(19) United States
(12) Patent Application Publication
(10) Pub. No.: US 2011/0037300 A1
(43) Pub. Date: Feb. 17, 2011

(54) SHOCK-ABSORBING SEAT SYSTEM

(76) Inventors: Marc Pettigrew, Sidney (CA); Paul Taylor, Victoria (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/811,812

(22) PCT Filed: Dec. 5, 2008
(86) PCT No.: PCT/CA08/02122

§ 371 Date: Oct. 29, 2010

Related U.S. Application Data
(60) Provisional application No. 61/012,054, filed on Dec. 7, 2007.

(51) Int. Cl. A47C 1/00; A47C 15/00; A47C 7/35; A47C 7/14; F16F 7/00

(52) U.S. Cl. 297/232; 297/344.18; 297/344.19; 248/636

(57) ABSTRACT

A shock-absorbing structure comprises a frame having front and rear sides. The frame provides mounting points for first and second shock-absorbing assemblies. The mounting points are located side-by-side across a transverse dimension of the frame and may be provided on a single frame member. The frame has front and rear faces each capable of supporting a linear slide to which a seat or other item may be attached. A first shock-absorbing assembly is mounted to the first mounting point and coupled to a first seat or other item supported on a linear slide on one of the front and rear faces of the frame. The shock absorbing structure may be applied to support seats in a boat or other vehicle.

### CROSS-REFERENCE TO RELATED APPLICATION

This application claims priority from U.S. patent application No. 61/012,054 filed on 7 Dec. 2007 and entitled SHOCK-ABSORBING SEAT SYSTEM. For purposes of the United States of America, this application claims the benefit under 35 U.S.C. §119 of U.S. patent application No. 61/012,054 filed on 7 Dec. 2007 and entitled SHOCK-ABSORBING SEAT SYSTEM which is hereby incorporated herein by reference.

### TECHNICAL FIELD

This invention relates to shock-absorbing seats. The invention has application, for example, in seats for small fast boats that may be used in rough waters.

### BRIEF DESCRIPTION OF DRAWINGS

Exemplary embodiments are illustrated in referenced figures of the drawings. The embodiments and figures disclosed herein are illustrative and non-limiting.

FIG. 1A is a schematic description of a forward-facing seat according to one embodiment of the invention.

FIG. 1B is a schematic view of a rearward-facing seat according to an embodiment of the invention.

FIG. 1C is a schematic view of a forward-facing seat according to another embodiment of the invention.

FIG. 1D is a schematic depiction of back to back seats according to another embodiment of the invention.

FIG. 1E is a schematic view of two forward-facing seats mounted to a single shock-absorbing support according to another embodiment of the invention.

FIG. 1F shows an assembly comprising a storage bin supported by a shock-absorbing support assembly according to another embodiment.

FIG. 2 is a side elevation view showing front and rear seats arranged generally as shown in FIG. 1E.

FIG. 2A is a perspective view from the rear of the seats shown in FIG. 2.

FIG. 2B is a cross section though the seats shown in FIG. 2.

FIG. 2C is a transverse cross sectional view in the plane of the seat support of the seats of FIG. 2.

FIG. 3 is a perspective view of a frame for a shock-absorbing seat mount according to a embodiment of the invention.

FIG. 3A is a side elevation view of the seat mount shown in FIG. 3.

FIG. 4 is a perspective view from the rear showing a seat frame like that of FIG. 3 supporting one forward-facing seat.

FIG. 4A is a side elevation view of the seat of FIG. 4.

FIG. 5 is a rear elevation view showing a support like that of FIG. 3 supporting a forward-facing seat.

FIG. 5A is a side elevation view of the seat of FIG. 5.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

This invention relates to seats for use in situations in which significant shock is expected. The invention may be applied, for example, to providing seats in rough-water boats, rough-terrain vehicles, or the like. An example application provides seating in small fast boats for transporting military personnel.

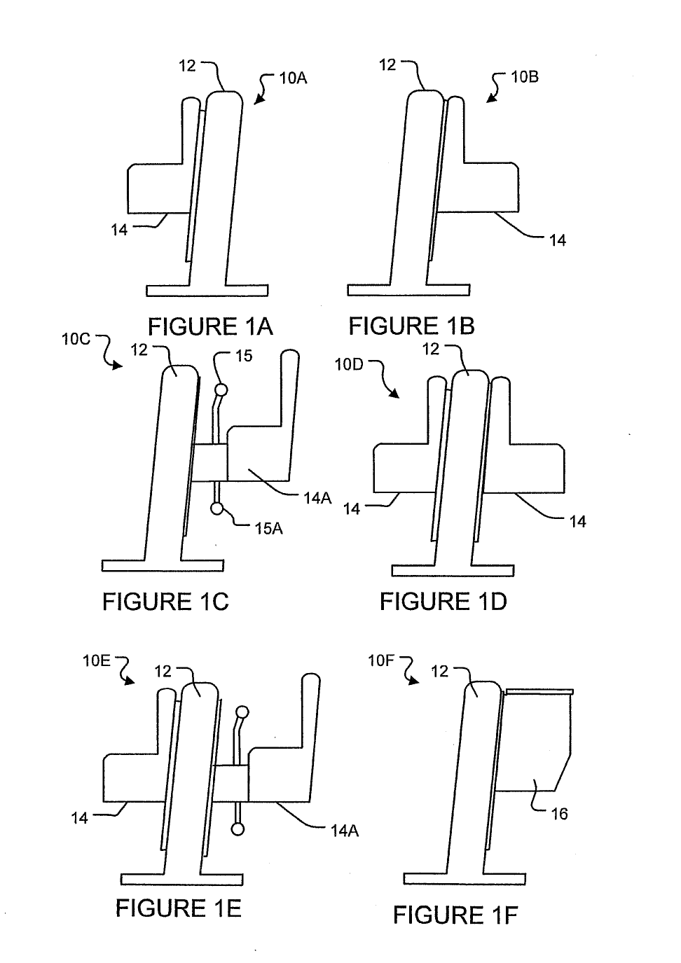

FIGS. 1A to 1E show various seating configurations. FIG. 1A shows a seating assembly 10A comprising a shock-absorbing support structure 12 supporting a seat 14 in a forward-facing orientation.

FIG. 1B shows a seating structure 10B comprising a shock-absorbing support 12 supporting a seat 14 in a rearward-facing orientation.

FIG. 1C shows a seating assembly 10C comprising a shock-absorbing support 12 supporting a forward-facing seat 14A on a rearward side of the shock-absorbing support 12. Seat 14A has a handgrip 15 and foot pegs 15A.

FIG. 1D shows a seating structure 10D comprising forward and rearward-facing seats 14 both mounted to a single shock-absorbing support structure 12.

FIG. 1E shows a seating assembly 10E showing two forward-facing seats 14 and 14A both supported by a shock-absorbing support structure 12.

FIG. 1F shows a assembly 10E comprising a storage bin 16 supported by a shock-absorbing support structure 12.

In FIGS. 1A through 1F the shock-absorbing support structure is inclined in a rearward direction (toward the right-hand side of the figures). This is not mandatory for all embodiments. The shock-absorbing support structure could be inclined slightly forwardly, slightly rearwardly (as shown) or could extend at right angles to its base.

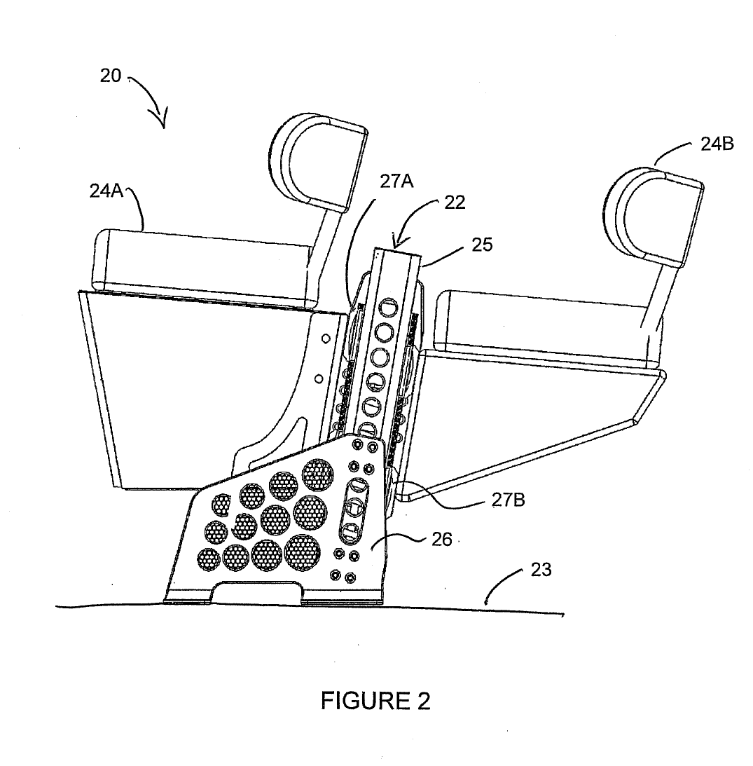

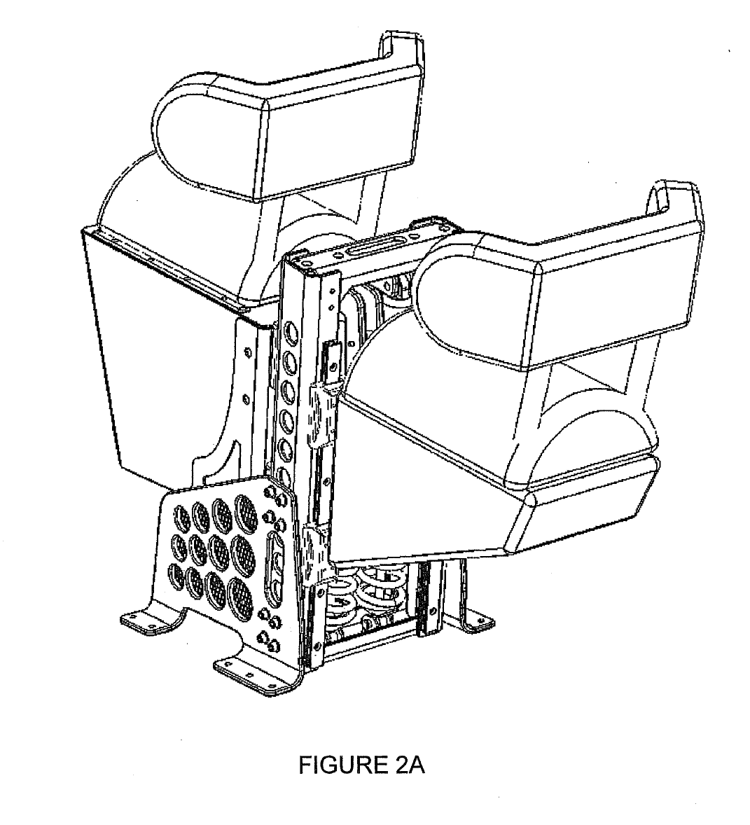

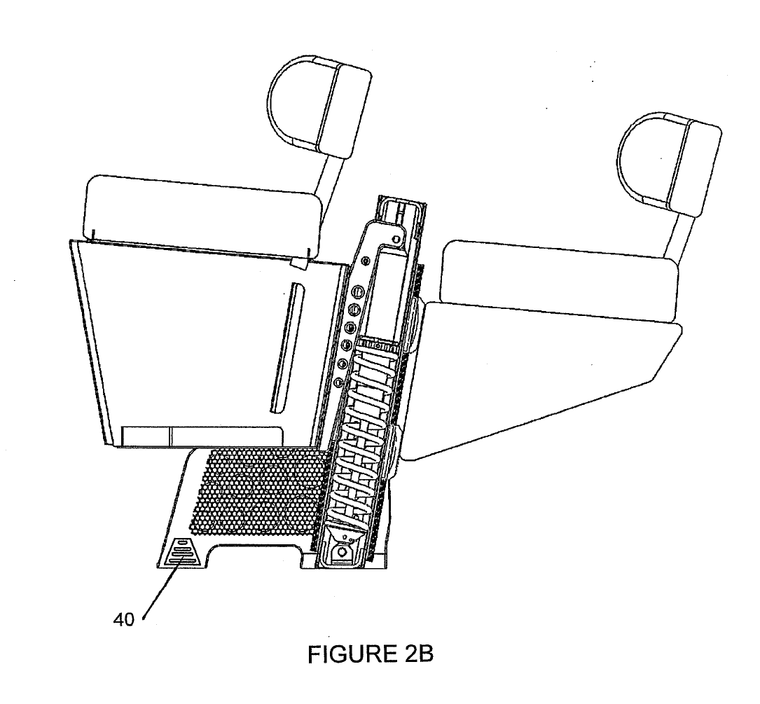

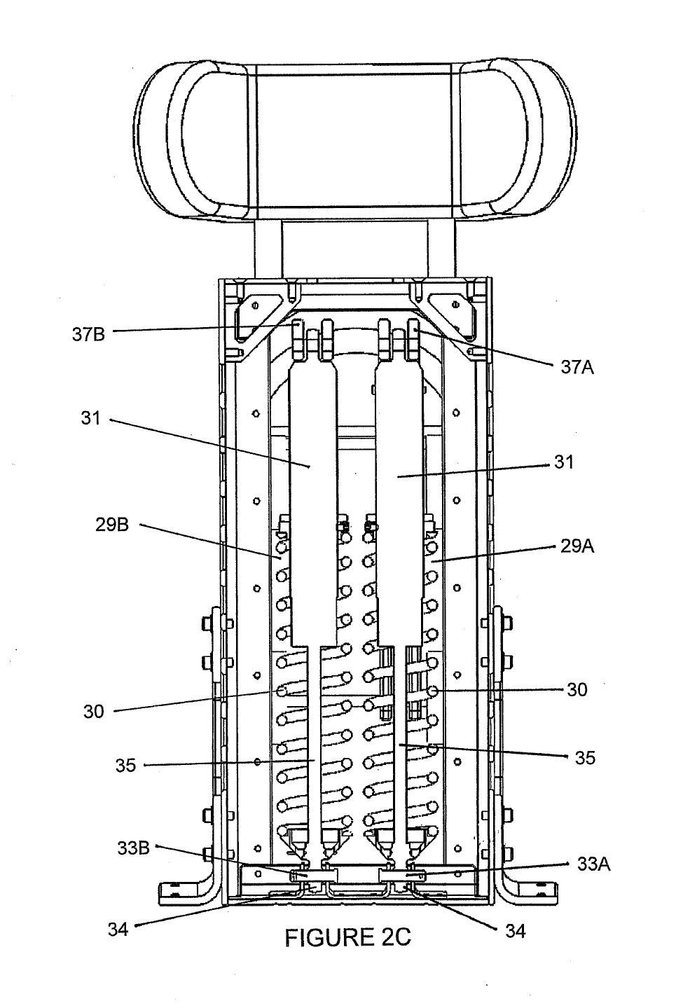

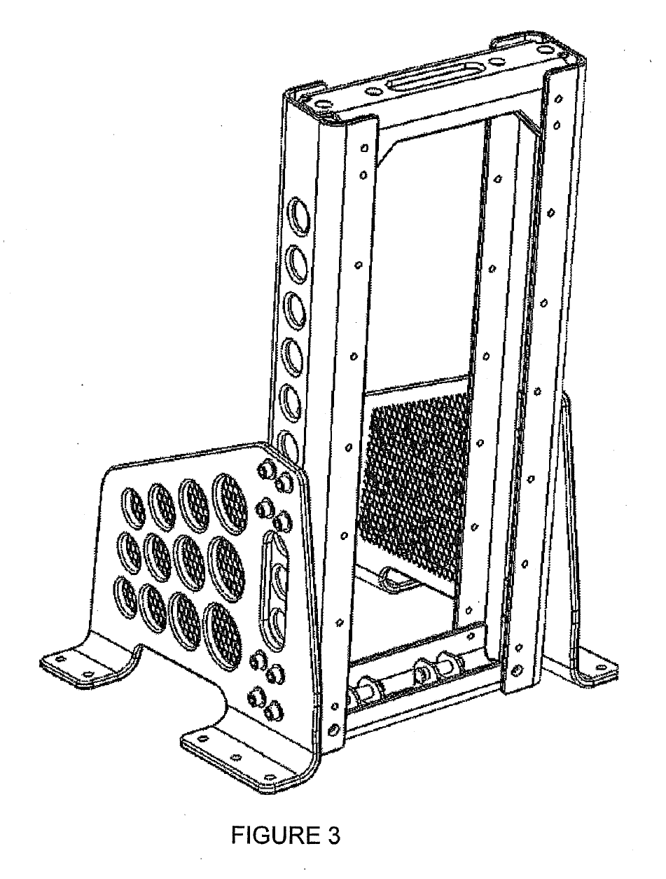

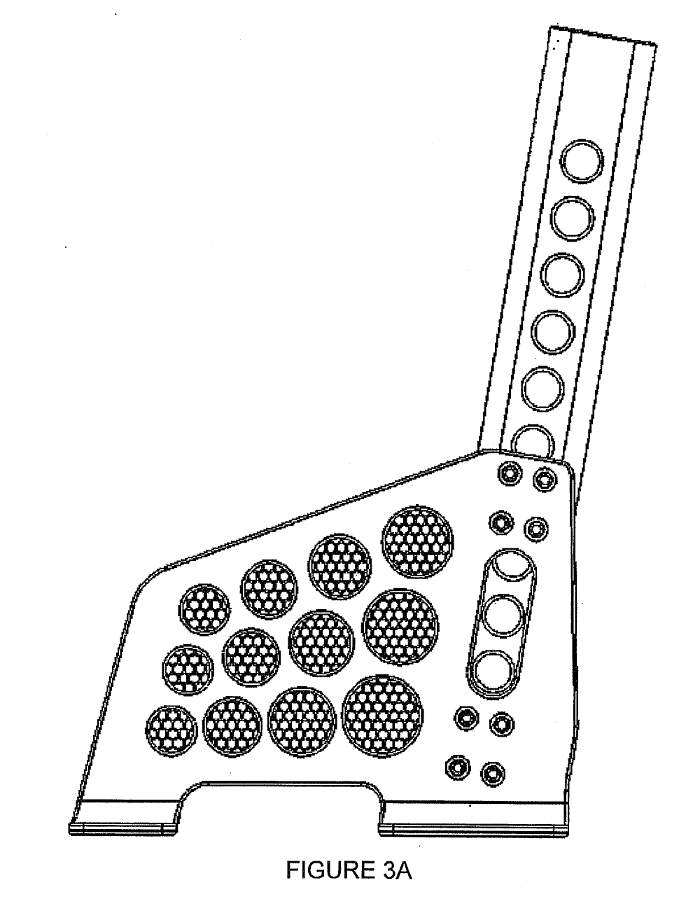

FIG. 2 shows a seat assembly 20 according to a specific embodiment of this invention. Seat assembly 20 comprises a support structure 22 which supports seats 24A and 24B. As described further below, support structure 22 incorporates shock-absorbers which allow seats 24A to move up and down relative to structure 22 in response to vibrations, jolts, shocks, heaving or other motions of deck 23 to which shock-absorbing support structure 22 is mounted. Deck 23 could, for example, be the deck of a boat.

In the illustrated embodiment, support structure 22 comprises a central frame 25 which is affixed to deck 23 by way of braces 26 located on either side of frame 25. Seats 24A and 24B are slidably mounted to frame 25 by way of slide assemblies 27A and 27B. Slide assemblies 27A and 27B may comprise, for example, commercially available linear slides. Slide assemblies 27A and 27B permit seats 24A and 24B to slide linearly up and down on frame 25 but otherwise constrain the motions of seats 24A and 24B.

Seat assembly 20 is preferably made from durable materials that are able to withstand factors in the environment in which seat assembly 20 will be used. For example, where seat assembly 20 will be used in a marine environment, stainless steel, aluminum, suitable high-strength plastics or other corrosion resistant materials may be used for frame 25, brackets 26 and exposed parts of seats 24A and 24B.

As shown best in FIG. 2C, shock-absorber assemblies 29A and 29B support seats 24A and 24B respectively. Shock-absorber assemblies 29A and 29B each comprise a spring 30 and a motion damping mechanism 31. The motion damping mechanism 31 may comprise for example a piston type hydraulic or pneumatic shock-absorber. In the illustrated embodiment, shock-absorbing assemblies 29A and 29B each comprise a coil-over shock-absorber. Each of shock-absorber assemblies 29 is coupled to frame 25 at a lower end. In the illustrated embodiment, these couplings are pivotal couplings in which pins 33A and 33B pass through ball joints 34 on the ends of rods 35 of motion dampers 31.

The upper ends of each of shock-absorbing assemblies 29A and 29B are coupled to the corresponding seats 24A and 24B by hangers 37A and 37B respectively. Each hanger 37 is pivotally mounted at the top of the corresponding shock-absorbing assembly 29 and has a lower end coupled to the corresponding seat 24.

Frame 25 may have any suitable construction. In the illustrated embodiment, frame 25 comprises a number of frame members that are fastened together with suitable fasteners such as screws, bolts, rivets, adhesives or the like. In alternative embodiments, frame 25 may be welded together or made from a unitary piece of material.

It can be seen from FIG. 2C that, in the illustrated embodiment, shock-absorbing assemblies 29A and 29B are located on either side of a mid-plane that bisects frame 25 along a longitudinal axis. This mid-plane may be called a “transverse median”. It can also be seen that cylinders of shock absorbing assemblies 29A and 29B lie in a common plane that is generally parallel to planes of front and rear faces of frame 25.

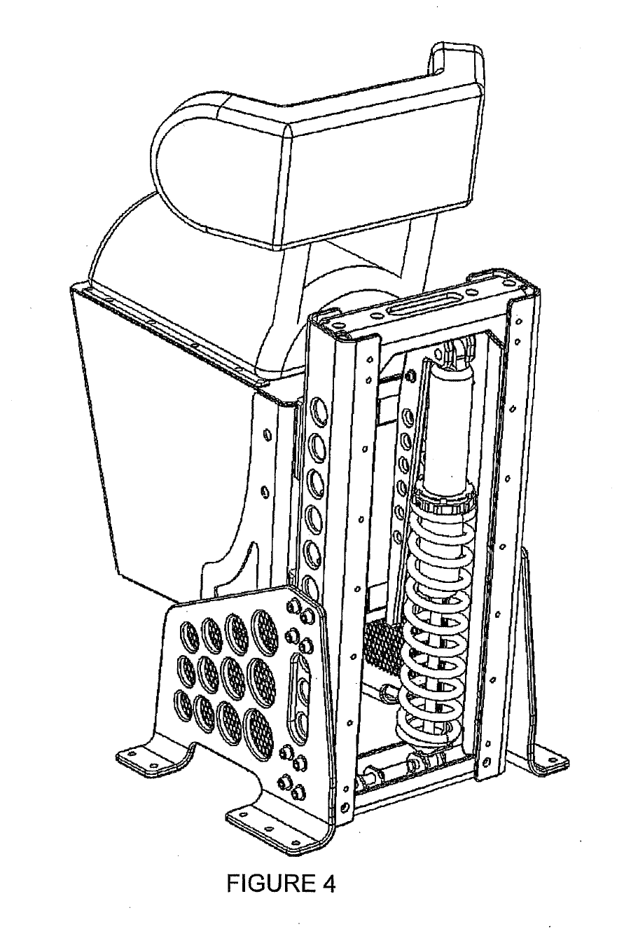

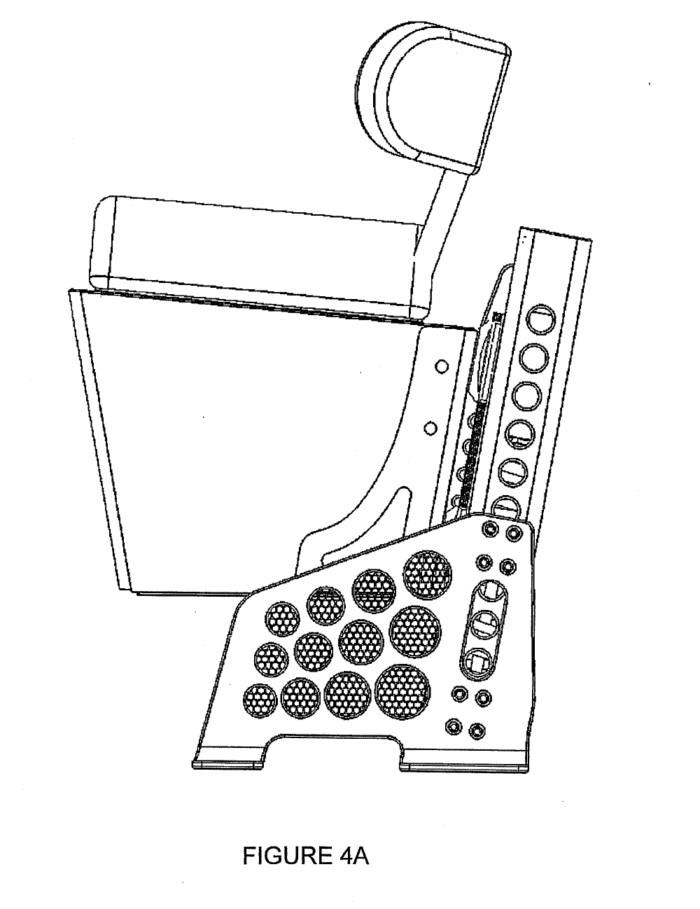

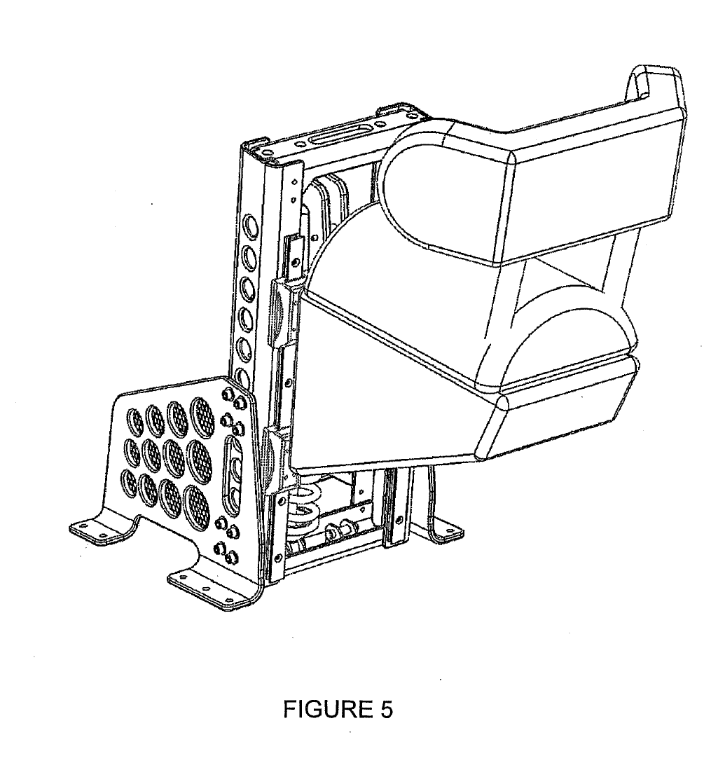

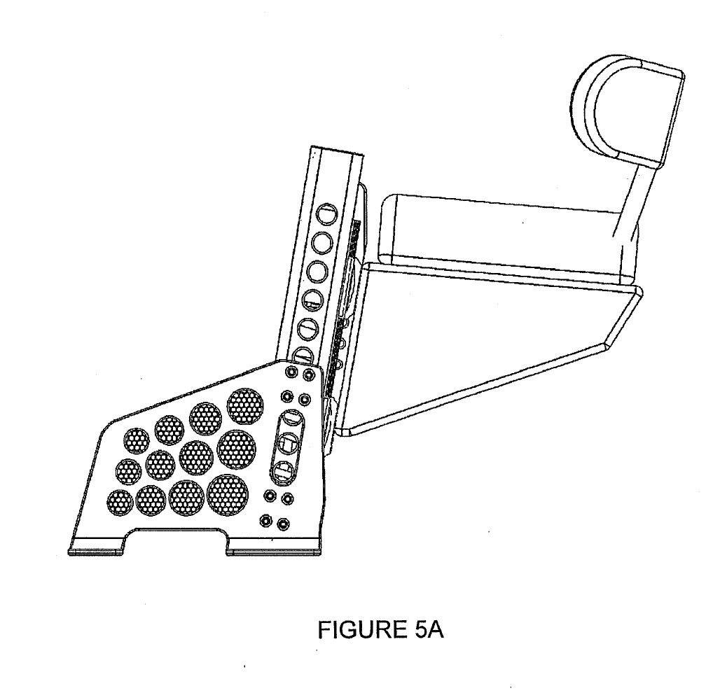

As shown in FIGS. 4 to 5A, a single shock-absorbing support structure 22 can support either a seat on a forward side of the support structure 22, a seat on the rearward side of the shock-absorbing structure 22 or seats on both the forward and rearward sides of shock-absorbing structure 22. Further, to add a seat to a shock-absorbing structure 22 that has been configured for use with one seat, is only necessary to add a suitable slide assembly 27, if not already present, a suitable shock-absorbing assembly 29, a hanger 37, and the new seat 24. This can preferably be done without removing structure 22.

In use, the weight of a seat 24 and person riding in the seat 24 is supported by the spring 30 of the corresponding shock-absorbing assembly 29.

If there is any sudden motion of shock-absorbing support structure 22 in a vertical direction relative to seats 24, then seats 24 can slide relative to the shock-absorbing structure 22. Motion damping mechanisms 31 damp the relative motion of seats 24 and structure 22.

It is usually desirable but not mandatory that shock-absorber assemblies 19A and 19B be the same. If the weights being supported on front seat 24A and rear seat 24B (or other things being supported by support structure 22) are very different then it would be possible to supply shock-absorbing assemblies 19A and 19B that are different from one another. For example, the spring constants of springs 30 could be different from one another or the springs could be adjusted to have different amounts of pre-compression.

Structures according to the illustrated embodiments have a number of advantages that may be useful in individual applications. For example:
The side-by-side arrangement of shock-absorbing assemblies 29 makes the structure compact in a front-rear direction. This can be important in providing seating in small boats, for example.
The overall compact nature of shock-absorbing structure 22 allows shock-absorbing structure 22 to be compact and light in weight.
Shock-absorbing structure 22 can be short in the forward-rearward dimension. It is not necessary for the shock-absorbing structure to be much larger in this dimension than the diameter of a shock-absorbing assembly 29. In some embodiments, the thickness of shock-absorbing structure 22 in the forward-rearward dimension does not exceed 1½ times (1¼ times in some embodiments) the diameter of coil spring 30 of shock-absorbing assembly 29.
The shock-absorbing structure 22 is versatile because it can accept seats, storage containers, or other equipment which is to be protected from shocks on either or both its front and rear sides.
The same shock-absorbing structure 22 may support seats or other apparatus on either one or both of its sides.

A bump-stop (or snubbing assembly) may be provided to limit the maximum downward travel of seats 24A and/or 24B relative to support structure 22. In some embodiments, the snubbing assembly is provided directly below the center of gravity of the seat 24A or 24B. For example, the snubbing assembly may be located on deck 23. This arrangement has the advantage that it reduces forces that tend to pull the seat 24A or 24B away from support structure 22 when the seat hits the snubbing assembly. In other embodiments, the snubbing assembly may be provided on the rod of the corresponding shock-absorbing assembly or provided in some other manner. The snubbing assembly may comprise, for example, an elastomer or other resilient bumper, a spring, an air bag, or a suitable combination thereof. FIG. 2B shows an example bump stop 40.

A further benefit of mounting seats on front and back sides of the same frame 25 is that loads are balanced when the frame 25 is called upon to absorb shocks. This means that frame 25 does not need to absorb off-balance loads. Frame 25 can therefore be lighter in weight while still rigid.

In some embodiments, the ends of shock-absorbing assemblies 29 that are connected to frame 25 both connect to the same member of frame 25.

The invention has a range of aspects. These aspects include, without limitation:
A shock-absorbing structure comprising a frame having front and rear sides, the frame providing mounting points for first and second shock-absorbing assemblies, the mounting points located side-by-side across a transverse dimension of the frame. The frame is capable of supporting linear slides to which seats or other items may be attached on each of its front and rear sides. The shock-absorbing structure has a coupling connecting each attached item to one of the shock-absorbing assemblies.
Apparatus having any new, inventive and useful feature, combination of features or sub-combination of features described herein and/or depicted in the appended drawings.
Methods for mounting seats or other items to shock-absorbing supports as described herein.
Methods for adding a seat or other item to a previously-installed shock-absorbing support as described herein.

As will be apparent to those skilled in the art in the light of the foregoing disclosure, many alterations and modifications are possible in the practice of this invention without departing from the spirit or scope thereof. While a number of exemplary aspects and embodiments have been discussed above, those of skill in the art will recognize certain modifications, permutations, additions and sub-combinations thereof. It is therefore intended that the invention encompasses all such modifications, permutations, additions and sub-combinations that are new, useful and non-obvious.

1. A seat assembly comprising:
a frame;
a seat slidably mounted to the frame; and
a shock-absorber assembly coupled between the seat and a mounting point on the frame, wherein an upper end of the shock-absorber assembly is coupled to the seat by a hanger having an upper end coupled to the shock-absorbing assembly and a lower end coupled to the seat.

2. A seat assembly according to claim 1 wherein the shock-absorber assembly comprises a spring and a motion damping mechanism.

3. A seat assembly according to claim 2 wherein the motion damping mechanism comprises a piston type hydraulic or pneumatic shock-absorber.

4. A seat assembly according to claim 2 wherein the shock absorber assembly comprises a coil-over shock-absorber.

5. A seat assembly according to claim 2 wherein a thickness of the frame is 1½ times or less a diameter of the spring.

6. A seat assembly according to claim 1 wherein the mounting point comprises a pin and the shock absorber assembly is pivotally coupled to the mounting point by a ball joint.

7. A seat assembly according to claim 1 wherein the seat constitutes a first seat supported on a first face of the frame and the seat assembly comprises a second seat supported on a second face of the frame, the second seat slidably mounted to the frame, the seat assembly comprising a second shock-absorber assembly coupled between the second seat and a second mounting point of the frame.

8. A seat assembly according to claim 7 wherein the first and second shock absorber assemblies extend substantially parallel to one another.

9. A seat assembly according to claim 7 wherein the first and second mounting points comprise a single frame member and both the first and second shock absorbing assemblies are coupled to the single frame member.

10. A seat assembly according to claim 9 wherein the single frame member comprises a horizontal transverse rod.

11. A seat assembly according to claim 7 wherein the first and second faces are opposing faces of the frame and wherein the first shock absorber assembly is on a first side of the frame extending between the first and second faces and the second shock absorber assembly is on a second side of the frame opposing the first side.

12. A seat assembly according to claim 7 wherein first and second shock absorber assemblies are the same.

13. A seat assembly according to claim 1 wherein the seat is removably mounted to the frame by a linear slide.

14. A seat assembly according to claim 1 comprising a snubbing assembly below the seat to limit a maximum downward travel of the seat.

15. A seat assembly according to claim 14 wherein the snubbing assembly is provided directly below a center of gravity of the seat.

16. A seat assembly according to claim 14 wherein the frame is mounted to a deck and the snubbing assembly is mounted to the deck.

17. A seat assembly according to claim 14 wherein the snubbing assembly comprises a resilient bumper, a spring, an air bag or a combination thereof.

18. A seat assembly according to claim 14 wherein the snubbing assembly is provided on a rod of the shock absorbing assembly.

19. A shock-absorbing structure comprising a frame having front and rear faces, the frame providing mounting points for first and second shock-absorbing assemblies, the mounting points located side-by-side across a transverse dimension of the frame, the front and rear faces each adapted to support a linear slide to which a seat or other item may be attached, wherein the first shock-absorbing assembly is mounted to the first mounting point and coupled to a first seat or other item supported on a first linear slide on one of the front and rear faces of the frame.

20. A structure according to claim 19 wherein the frame is significantly wider in the transverse dimension than a perpendicular distance between the front and rear faces.

21. A shock-absorbing structure comprising a frame having first and second faces, the first face substantially parallel to and opposing the second face, each face having a height in a longitudinal dimension and a width in a transverse dimension, the first and second faces being spaced apart by a thickness of the frame, the frame providing mounting points for first and second shock-absorbing assemblies, the mounting points located side-by-side in the transverse dimension, one mounting point on each side of a transverse median of the frame, wherein the first shock-absorbing assembly is mounted to the first mounting point and is adopted to be coupled to a seat or other item slideably mounted on the first face and the second shock-absorbing assembly is mounted to the second mounting point, the shock-absorbing assemblies located between the first and second faces and extending parallel to one another.

22. A shock absorbing structure according to claim 21 wherein the thickness of the frame does not exceed 1½ times a maximum diameter of the first and second shock-absorbing assemblies.

23. A method for adding a second seat to a shock-absorbing structure comprising a frame having first and second faces, the frame providing mounting points for first and second shock-absorbing assemblies, the shock-absorbing structure mounted to a deck and supporting a first seat mounted to a first slide assembly on the first face, the method comprising:
mounting a second slide assembly to the second face;
mounting the second shock-absorbing assembly to the second mounting point;
mounting the second seat on the second slide assembly; and
coupling a hanger between the second shock-absorbing assembly and the second seat, wherein an upper end of the hanger is coupled to the shock-absorbing assembly and a lower end is coupled to the seat.
